(19) United States
(12) Patent Application Publication
(10) Pub. No.: US 2026/0121017 A1
(43) Pub. Date: Apr. 30, 2026

(54) ELECTRODE AND NON-AQUEOUS ELECTROLYTE SECONDARY BATTERY

(71) Applicant: TOYOTA JIDOSHA KABUSHIKI KAISHA, Toyota-shi (JP)

(72) Inventor: Shinichiro ITO, Kosai-shi (JP)

(73) Assignee: TOYOTA JIDOSHA KABUSHIKI KAISHA, Toyota-shi (JP)

(21) Appl. No.: 19/317,722

(22) Filed: Sep. 3, 2025

(30) Foreign Application Priority Data
Oct. 25, 2024 (JP) 2024-188082

(51) Int. Cl. H01M 4/13; H01M 4/02

(52) U.S. Cl. CPC H01M 4/13; H01M 2004/021

(57) ABSTRACT

An electrode includes a current collector and an active material layer, the active material layer includes a first active material layer formed on the current collector, and a second active material layer formed on the first active material layer and the current collector located around the first active material layer, so as to cover the first active material layer, a reaction resistance of the second active material layer is lower than a reaction resistance of the first active material layer, and a diffusion resistance of the first active material layer is lower than a diffusion resistance of the second active material layer.

### CROSS REFERENCE TO RELATED APPLICATIONS

This nonprovisional application is based on Japanese Patent Application No. 2024-188082 filed on October 25, 2024 with the Japan Patent Office, the entire contents of which are hereby incorporated by reference.

### BACKGROUND

### Field

The present disclosure relates to an electrode and a non-aqueous electrolyte secondary battery.

### Description of the Background Art

Japanese Patent Laying-Open No. 2013-149403 discloses a negative electrode for a lithium-ion secondary battery, which includes a negative electrode first layer formed on a negative electrode current collector and a negative electrode second layer formed on the negative electrode first layer, and in which an average particle size of a negative electrode active material contained in the negative electrode second layer is smaller than an average particle size of a negative electrode active material contained in the negative electrode first layer.

### SUMMARY

In order to ensure good input/output characteristics over a long period of time, it is necessary to reduce the reaction resistance and efficiently move lithium ions from the electrode surface toward the current collector. To overcome this problem, Japanese Patent Laying-Open No. 2013-149403 discloses a negative electrode having the above-described characteristics. However, there is room for improvement in suppression of increase in reaction resistance.

An object of the present disclosure is to provide a novel electrode that enables suppression of increase in reaction resistance.

[1] An electrode including a current collector and an active material layer, wherein

the active material layer includes a first active material layer formed on the current collector, and a second active material layer formed on the first active material layer and the current collector located around the first active material layer, so as to cover the first active material layer,

a reaction resistance of the second active material layer is lower than a reaction resistance of the first active material layer, and

a diffusion resistance of the first active material layer is lower than a diffusion resistance of the second active material layer.

Since the second active material layer is formed so as to cover the first active material layer, the second active material layer is used for battery reaction at the start of the battery reaction. The reaction resistance of the second active material layer is lower than the reaction resistance of the first active material layer. Accordingly, increase in reaction resistance is expected to be suppressed.

After the start of the battery reaction, the first active material layer may be used for the battery reaction. The diffusion resistance of the first active material layer is lower than the diffusion resistance of the second active material layer. Accordingly, increase in diffusion resistance is expected to be suppressed.

[2] The electrode according to [1], wherein

the first active material layer includes a first active material,

the second active material layer includes a second active material, and

an average particle size of the second active material is smaller than an average particle size of the first active material.

[3] The electrode according to [1] or [2], wherein

the first active material layer includes a first binder,

the second active material layer includes a second binder, and

a content of the second binder in the second active material layer is lower than a content of the first binder in the first active material layer.

[4] The electrode according to any one of [1] to [3], wherein a coating weight per unit area of the second active material layer is smaller than a coating weight per unit area of the first active material layer.

[5] The electrode according to any one of [1] to [4], wherein the active material layers are formed at intervals.

[6] A non-aqueous electrolyte secondary battery including an electrode according to any one of [1] to [5].

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual diagram showing an example of a non-aqueous electrolyte secondary battery according to the present embodiment.

FIG. 2 is a schematic cross-sectional view illustrating an example of an electrode according to the present embodiment.

FIG. 3 is a schematic cross-sectional view illustrating another example of the electrode according to the present embodiment.

FIG. 4A is a schematic cross-sectional view showing a configuration of a negative electrode in an Example.

FIG. 4B is a schematic cross-sectional view showing a configuration of a negative electrode in an Example.

FIG. 4C is a schematic cross-sectional view showing a configuration of a negative electrode in an Example.

FIG. 4D is a schematic cross-sectional view showing a configuration of a negative electrode in an Example.

FIG. 4E is a schematic cross-sectional view showing a configuration of a negative electrode in an Example.

FIG. 5 shows tables illustrating configurations of a negative electrode and experimental results in Examples.

### DESCRIPTION OF THE PREFERRED EMBODIMENTS

Hereinafter, one embodiment of the present disclosure (hereinafter, it may be abbreviated as "the present embodiment") and one example of the present disclosure (hereinafter, it may be abbreviated as "the present example") will be described. However, the present embodiment and the present example do not limit the technical scope of the present disclosure. The present embodiment and the present example are illustrative in all respects. The present embodiments and examples are non-limiting. The technical scope of the present disclosure includes all modifications within the meaning and range equivalent to the description of the claims. For example, an arbitrary configuration is extracted from the present embodiment, and it is also planned from the beginning that they are arbitrarily combined.

In the present specification, when a compound is represented by a stoichiometric composition formula such as "LiCoO₂", the stoichiometric composition formula is merely a representative example. For example, when lithium cobaltate is expressed as "LiCoO₂", unless otherwise specified, lithium cobaltate is not limited to a composition ratio of "Li/Co/O=1/1/2", and may contain Li, Co, and O at an arbitrary composition ratio. The composition ratio may be non-stoichiometric.

The "reaction resistance" indicates a resistance that is dominant in 0 to 1 second after the start of the battery reaction among the resistances. The "diffusion resistance" indicates a resistance that is dominant after one second from the start of the battery reaction.

The "average particle size (D50)" indicates a particle size at which integration is 50% in a volume-based particle size distribution (integrated distribution). The particle size distribution may be measured by laser diffraction.

The "electrode" may be a positive electrode, a negative electrode, or a bipolar electrode. The "non-aqueous electrolyte secondary battery" may also be abbreviated as a "battery". The "battery" may be a monopolar battery or a bipolar battery.

### Non-aqueous Electrolyte Secondary Battery

FIG. 1 is a conceptual diagram showing an example of a non-aqueous electrolyte secondary battery according to the present embodiment. The battery 100 includes a power generation element 50. The battery 100 may include an exterior package. The exterior package may house the power generation element 50. The exterior package may be, for example, a metal case or a pouch made of an aluminum laminate film. The exterior package may be provided with a positive electrode terminal and a negative electrode terminal. The power generation element 50 includes a negative electrode 10, a separator 30, and a positive electrode 20. The power generation element 50 may be connected to a positive electrode terminal and a negative electrode terminal.

The negative electrode 10 includes a negative electrode current collector 11 and a negative electrode active material layer 12. The negative electrode current collector 11 may include, for example, a copper (Cu) foil or the like. The negative electrode active material layer 12 includes a negative electrode active material and a binder. The negative electrode active material layer 12 may further contain, for example, a conductive material or the like. The conductive material may include, for example, carbon nanotubes (CNTs) or the like. The blending amount of the conductive material may be, for example, 0.1 to 10% in mass fraction.

The positive electrode 20 includes a positive electrode current collector 21 and a positive electrode active material layer 22. The positive electrode current collector 21 may include, for example, an Al foil or the like. The positive electrode active material layer 22 includes a positive electrode active material and a binder. The positive electrode active material layer 22 may further contain, for example, a conductive material or the like. The conductive material may include, for example, acetylene black (AB) or the like. The blending amount of the conductive material may be, for example, 0.1 to 10% in mass fraction.

The separator 30 is porous. The separator 30 can permeate the electrolyte solution. The separator 30 separates the negative electrode 10 from the positive electrode 20. The separator 30 is electrically insulating. The separator 30 may include, for example, a polyolefin-based resin such as polyethylene (PE) or polypropylene (PP). The separator 30 may have, for example, a single-layer structure or a multilayer structure. The separator 30 may be substantially composed of, for example, a PE layer, or may be formed by stacking a PP layer, a PE layer, and a PP layer in this order.

The electrolyte solution includes a solvent and a Li salt. The solvent is aprotic. The solvent may include any ingredient. The solvent may include, for example, at least one selected from the group consisting of ethylene carbonate (EC), dimethyl carbonate (DMC), and ethyl methyl carbonate (EMC).

The Li salt is a supporting electrolyte. The Li salt is dissolved in the solvent. The Li salt may contain, for example, at least one selected from the group consisting of LiPF₆, LiTFSI, and LiBF₄. The Li salt may have a molar concentration of, for example, 0.5 mol/L or more and 2.0 mol/L or less.

The electrolyte solution may further contain an optional additive. The electrolyte solution may contain, for example, 0.01 mass % or more and 5 mass % or less of an additive. The additive may include, for example, at least one selected from the group consisting of vinylene carbonate (VC), vinylethylene carbonate (VEC), and the like. Instead of the electrolyte solution, a gel electrolyte or a solid electrolyte may be used.

### Electrode

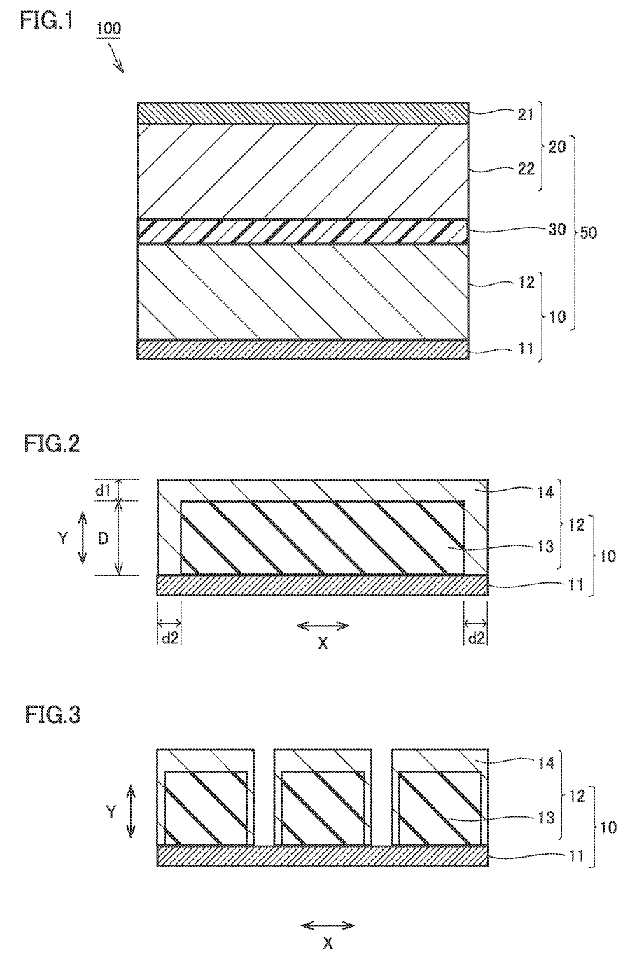

FIG. 2 is a schematic cross-sectional view illustrating an example of an electrode in the present embodiment. FIG. 2 illustrates a case where the electrode is a negative electrode. The negative electrode 10 includes a negative electrode current collector 11 and a negative electrode active material layer 12. The negative electrode active material layer 12 includes a first negative electrode active material layer 13 and a second negative electrode active material layer 14. The first negative electrode active material layer 13 is formed on the negative electrode current collector 11. The second negative electrode active material layer 14 is formed on the first negative electrode active material layer 13 and the negative electrode current collector 11 located around the first negative electrode active material layer, so as to cover the first negative electrode active material layer 13. The second negative electrode active material layer 14 covers the entire first negative electrode active material layer 13 so that the first negative electrode active material layer 13 is not exposed.

The reaction resistance of the second negative electrode active material layer 14 is lower than the reaction resistance of the first negative electrode active material layer 13. The diffusion resistance of the first negative electrode active material layer 13 is lower than the diffusion resistance of the second negative electrode active material layer.

The negative electrode active material layer 12 satisfying such a condition is obtained, for example, by satisfying at least one of the following (1) and (2).

(1) The first negative electrode active material layer 13 includes a first negative electrode active material, the second negative electrode active material layer 14 includes a second negative electrode active material, and the D50 of the second negative electrode active material is smaller than the D50 of the first negative electrode active material.

(2) The first negative electrode active material layer 13 includes a first binder, the second negative electrode active material layer 14 includes a second binder, and the content of the second binder in the second negative electrode active material layer 14 is lower than the content of the first binder in the first negative electrode active material layer 13.

### Regarding (1)

In general, an active material having a large D50 may be used to secure diffusion resistance and cycling performance, and an active material having a small D50 may be used to secure reaction resistance. In addition, current tends to concentrate at the end portions (both end portions in the X direction in FIG. 2) of the electrode (negative electrode) during the battery reaction. Therefore, by forming the second negative electrode active material layer 14 including the second negative electrode active material having a small D50 so as to cover the first negative electrode active material layer 13, increase in reaction resistance is expected to be suppressed.

In addition, since the D50 of the first negative electrode active material is larger than the D50 of the second negative electrode active material, it is considered that the first negative electrode active material layer 13 has more voids than the second negative electrode active material layer 14, and the electrolyte solution is easily diffused. Further, in the second negative electrode active material layer 14, the electrolyte solution is less likely to diffuse to the outside of the negative electrode than in the first negative electrode active material layer 13 having many voids. Therefore, as the battery reaction proceeds, the first negative electrode active material layer 13 is easily used for the battery reaction. This is expected to suppress increase in diffusion resistance.

The D50 of the second negative electrode active material is not particularly limited as long as it is smaller than the D50 of the first negative electrode active material. For example, the D50 of the first negative electrode active material may be 0.5 μm or more, 1 μm or more, or 2.5 μm or more. For example, the D50 of the first negative electrode active material may be less than 10 μm, 8 μm or less, or 6 μm or less. For example, the D50 of the second negative electrode active material may be 10 μm or more, 15 μm or more, or 20 μm or more. For example, the D50 of the second negative electrode active material may be 30 μm or less, 25 μm or less, or 20 μm or less.

The first negative electrode active material and the second negative electrode active material may be the same active material or different active materials. The first negative electrode active material and the second negative electrode active material are preferably the same active material. The negative electrode active material may contain, for example, at least one selected from the group consisting of graphite, soft carbon, and hard carbon. A similar negative electrode active material may also be used for (2).

The content of each negative electrode active material in the first negative electrode active material layer 13 and the second negative electrode active material layer 14 may be, for example, 50% or more, 60% or more, 70% or more, 80% or more, 90% or more, 95% or more, or 97% or more in mass fraction. Respective contents of the negative electrode active materials in respective negative electrode active material layers may be the same or different. The content may be the same for (2).

The first negative electrode active material layer 13 may include a first binder, and the second negative electrode active material layer 14 may include a second binder. The first binder and the second binder may be the same binder or different binders. Examples of such a binder include carboxymethyl cellulose (CMC) and styrene-butadiene rubber (SBR). Similar binders may also be used for (2). The blending amount of each binder may be, for example, 0.1 to 10% in mass fraction.

### Regarding (2)

In general, when the binder content is low, the binder coverage of the active material surface is low. Therefore, it is expected that increase in reaction resistance is suppressed by forming the second negative electrode active material layer 14 having a low binder content so as to cover the first negative electrode active material layer 13.

In addition, since the content of the first binder in the first negative electrode active material layer 13 is higher than the content of the second binder in the second negative electrode active material layer 14, it is considered that the first negative electrode active material layer 13 has more voids than the second negative electrode active material layer 14, and the electrolyte solution is easily diffused. Therefore, it is expected that increase in diffusion resistance is suppressed for the same reason as in the above (1).

The content of the second binder in the second negative electrode active material layer 14 is not particularly limited as long as it is lower than the content of the first binder in the first negative electrode active material layer 13. For example, the content of the first binder in the first negative electrode active material layer 13 may be 1% or more, 2% or more, 3% or more, or 5% or more in mass fraction. For example, the content of the first binder in the first negative electrode active material layer 13 may be 10% or less, 8% or less, 6% or less, or 5% or less in mass fraction. For example, the content of the second binder in the second negative electrode active material layer 14 may be 0.1% or more, 0.5% or more, 1% or more, or 2% or more in mass fraction. For example, the content of the second binder in the second negative electrode active material layer 14 may be 5% or less, 4% or less, 3% or less, or 2% or less in mass fraction.

The first binder and the second binder may be the same binder or different binders. The first binder and the second binder are preferably the same binder.

The first negative electrode active material layer 13 may include a first negative electrode active material, and the second negative electrode active material layer 14 may include a second negative electrode active material. The D50 of each negative electrode active material may be, for example, 0.5 to 30 μm.

### Coating Weight

The coating weight per unit area (second coating weight) of the second negative electrode active material layer 14 may be smaller than the coating weight per unit area (first coating weight) of the first negative electrode active material layer 13. Accordingly, suppression of increase in reaction resistance is expected. The ratio between the first coating weight and the second coating weight may be 50:50 to 95:5, or 55:45 to 85:15. The ratio between the first coating weight and the second coating weight may be 60:40 to 95:5, or 65:35 to 95:5. As a result, not only increase in the reaction resistance but also increase in the diffusion resistance is expected to be suppressed.

The total coating weight per unit area of the negative electrode active material layer 12, that is, the sum of the first coating weight and the second coating weight may be, for example, 10 mg/cm² or more, 15 mg/cm² or more, or 20 mg/cm² or more. From the viewpoint of increasing the capacity of the battery, it is preferably 20 mg/cm² or more.

As shown in FIG. 2, when the thickness (outer dimension in the Y direction) of the first negative electrode active material layer 13 is D and the difference between the thickness of the first negative electrode active material layer 13 and the thickness of the second negative electrode active material layer 14 is d1, d1 may be smaller than D. When the distance between the side surface of the second negative electrode active material layer 14 and the side surface of the first negative electrode active material layer 13 in the width direction (outer dimension in the X direction) of the second negative electrode active material layer 14 is d2, d2 may be smaller than D. Further, d1 and d2 may be substantially the same. At the ends of the electrode (negative electrode) (both ends in the X direction in FIG. 2), current tends to concentrate during the battery reaction. In addition, as the battery reaction proceeds, the first negative electrode active material layer 13 is easily used for the battery reaction. This is expected to suppress increase in diffusion resistance. Note that, at both end portions in the width direction, each distance is d2.

The contour of the first negative electrode active material layer 13 may be rectangular or circular.

As shown in FIG. 3, the negative electrode active material layers 12 may be formed at intervals (the negative electrode active material layer may be divided) in the width direction. As a result, it is expected that the area where the second negative electrode active material layer 14 comes into contact with the electrolyte solution increases, and increase in reaction resistance and diffusion resistance is suppressed. In FIG. 3, the negative electrode active material layer 12 is divided into three parts, but may be divided into a plurality of parts, for example, two parts.

Although an example in which the electrode is a negative electrode has been described above, the electrode may be a positive electrode. Even when the electrode is a positive electrode, increase in reaction resistance is expected to be suppressed by satisfying the above-described conditions.

In the case of the positive electrode, the positive electrode active material may include, for example, at least one selected from the group consisting of LiCoO₂, LiNiO₂, LiMnO₂, Li(NiCoMn)O₂, and Li(NiCoAl)O₂. For example, "(NiCoMn)" in "Li(NiCoMn)O₂" indicates that the total composition ratio in parentheses is 1. The amount of individual ingredients is arbitrary as long as the total is 1. The binder may include, for example, polyvinylidene difluoride (PVdF).

### Electrode Manufacturing Method

The method of manufacturing an electrode according to the present embodiment includes, for example, a step of preparing a slurry including an active material, a binder, and a solvent (a preparation step), a step of forming a coating film by applying the slurry to a current collector (a coating step), a step of drying the coating film (a drying step), and a step of forming an active material layer by compressing the coating film (a compression step). Hereinafter, an example of a method for producing a negative electrode as an electrode in the present embodiment will be described, but the present disclosure is not limited thereto.

### Preparation Step

In this step, a slurry containing a negative electrode active material, a binder, and a solvent is prepared. In this step, a conductive material or the like may be further added. For example, a slurry is prepared by mixing the negative electrode active material, the binder, the conductive material, and the solvent.

As the slurry, a first negative electrode slurry for forming the first negative electrode active material layer and a second negative electrode slurry for forming the second negative electrode active material layer are prepared. In the first negative electrode slurry and the second negative electrode slurry, the D50 of each negative electrode active material and the amount of each binder may be adjusted in order to obtain each target negative electrode active material layer. Any stirring device, mixing device, or dispersing device may be used to prepare each negative electrode slurry.

Examples of the solvent include an aqueous solvent and an organic solvent. Examples of the aqueous solvent include water. Examples of the organic solvent include N-methyl-2-pyrrolidone (NMP).

### Coating Step

In this step, each negative electrode slurry is applied to a negative electrode current collector to form a coating film. Any coating machine may be used for the coating.

A negative electrode current collector is prepared. The first negative electrode slurry is applied to the surface of the negative electrode current collector. The first negative electrode slurry is applied so that the first negative electrode active material layer has a desired first coating weight and a desired width. After the coating with the first negative electrode slurry, the second negative electrode slurry is applied to the surface of the first negative electrode slurry. The second negative electrode slurry is applied so that the second negative electrode active material layer has a desired second coating weight and a desired width. The width of the discharge portion of the coater at the time of coating with the second negative electrode slurry is set to be longer than the width of the discharge portion of the coater at the time of coating with the first negative electrode slurry.

### Drying Step

In this step, the solvent in the coating film is evaporated by drying the coating film. Any drying apparatus may be used for drying.

### Compression Step

In this step, each negative electrode active material layer is formed by compressing the coating film. Any compression device may be used for compression. The pressure may be adjusted so that the thickness of each negative electrode active material layer becomes a desired thickness.

Thus, the negative electrode is manufactured. The negative electrode manufactured by the above method may be formed to include the first negative electrode active material layer formed on the negative electrode current collector, and the second negative electrode active material layer formed on the first negative electrode active material layer and the negative electrode current collector located around the first negative electrode active material layer, so as to cover the first negative electrode active material layer.

### Examples

### Test Example 1

### Negative Electrode

### No. 1

A Cu foil was prepared as a negative electrode current collector, graphite (D50: 15 μm) was prepared as a first negative electrode active material, CNT was prepared as a conductive material, SBR was prepared as a binder, and water was prepared as a dispersion medium. The first negative electrode active material, the conductive material, the binder, and the dispersion medium were mixed to prepare a first negative electrode slurry. A mixing ratio of the first negative electrode active material, the conductive material, and the binder was 97:1:2 in mass fraction: . The negative electrode slurry was applied to the surface of the negative electrode current collector by a die coater and dried to form a negative electrode active material layer (coating weight per unit area: 20 mg/cm²). A negative electrode of No. 1 was produced by compressing the negative electrode active material layer.

### No. 2

A second negative electrode slurry was prepared in which the first negative electrode active material in the first negative electrode slurry was changed to graphite (D50: 5 μm) as a second negative electrode active material. A negative electrode of No. 2 was produced in the same manner as in No. 1, except that the second negative electrode slurry was used.

### No. 3

A first negative electrode slurry and a second negative electrode slurry were prepared. The first negative electrode slurry was applied to the surface of the negative electrode current collector by a die coater. The first negative electrode slurry was applied so that the coating weight after drying was 15 mg/cm². The second negative electrode slurry was applied onto the first negative electrode slurry by the die coater. At this time, the width of the discharge portion of the die coater at the time of coating with the first negative electrode slurry was the same as the width of the discharge portion of the die coater at the time of coating with the second negative electrode slurry. The second negative electrode slurry was applied so that the coating weight after drying was 5 mg/cm². The coating film was dried to form a negative electrode active material layer (total coating weight: 20 mg/cm²). A negative electrode of No. 3 was produced by compressing the negative electrode active material layer.

### No. 4

A negative electrode of No. 4 was produced in the same manner as in No. 3, except that the width of the discharge portion of the die coater at the time of coating with the second negative electrode slurry was set to be longer than the width of the discharge portion of the die coater at the time of coating with the first negative electrode slurry.

### No. 5

A negative electrode of No. 5 was produced in the same manner as in No. 4, except that the second negative electrode slurry and the first negative electrode slurry were applied in this order. The width of the discharge portion of the die coater at the time of coating with the first negative electrode slurry was set to be longer than the width of the discharge portion of the die coater at the time of coating with the second negative electrode slurry.

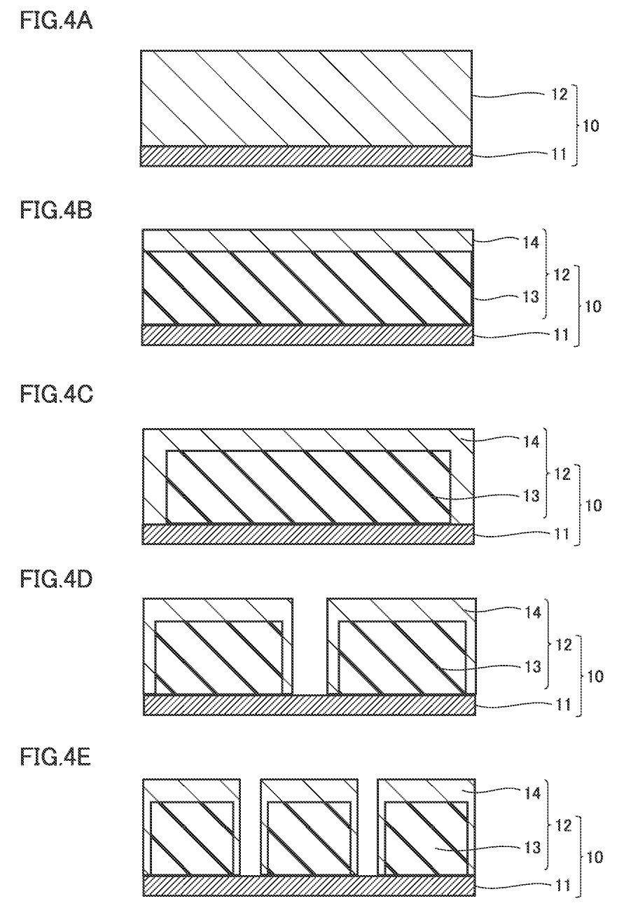

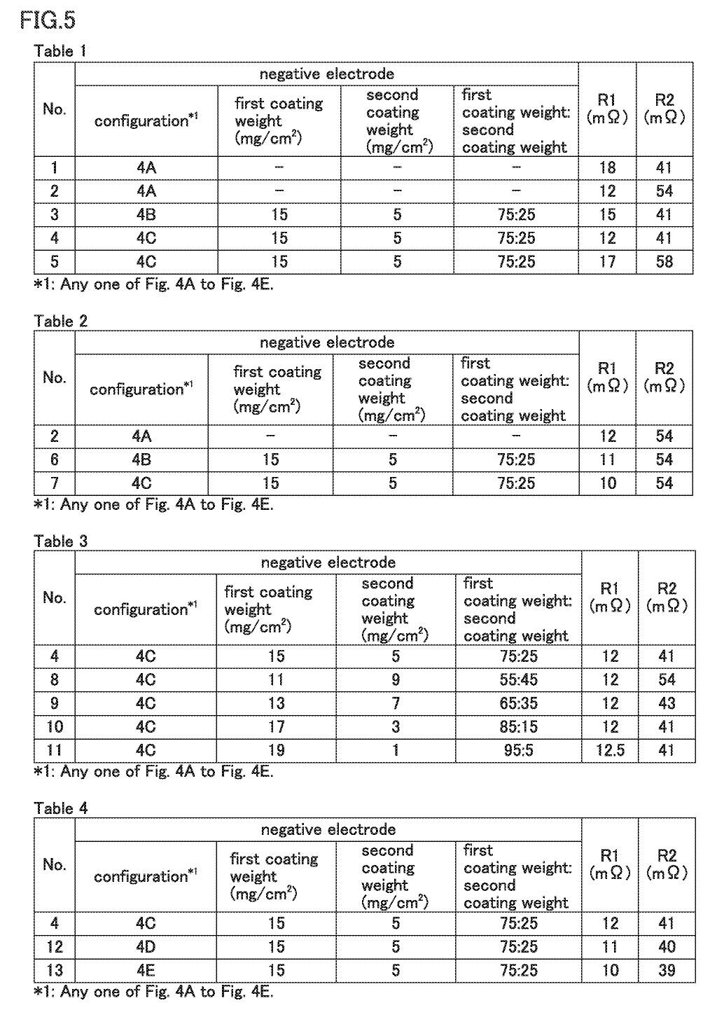

FIGS. 4A to 4E are each a schematic cross-sectional view showing the configuration of the negative electrode in the example. The configuration of the negative electrode of each No. that is any of those in FIGS. 4A to 4E is indicated in FIG. 5.

### Non-aqueous Electrolyte Secondary Battery

An Al foil was prepared as a positive electrode current collector, Li(Ni_{1/3}Co_{1/3}Mn_{1/3})O₂ was prepared as a positive electrode active material, CNT was prepared as a conductive material, PVdF was prepared as a binder, and NMP was prepared as a dispersion medium. A positive electrode slurry was prepared by mixing the positive electrode active material, the conductive material, the binder, and the dispersion medium. The mixing ratio (mass ratio) of the positive electrode active material, the conductive material, and the binder was 98:1:1. The positive electrode slurry was applied to the surface of the positive electrode current collector and dried to form a positive electrode active material layer (coating weight per unit area: 40 mg/cm²). The positive electrode active material layer was compressed to produce a positive electrode.

A resin film was prepared as a separator. The resin film had a three-layer structure (PP layer/PE layer/PP layer).

EC, DMC and EMC were mixed to prepare a mixed solvent. The mixing ratio (volume ratio) of EC, DMC, and EMC was 3:3:4. LiPF₆ (1.1 mol/L) were dissolved in the solvent to prepare an electrolyte solution.

A power generation element was formed by stacking the positive electrode, the separator, and the negative electrode of each No. in this order. An external terminal was attached to the power generation element. As a case, a pouch made of a laminate film was prepared. The power generation element was housed in the case. The power generation element and the terminal were electrically connected to each other. The electrolyte solution was injected into the case. After the electrolyte solution was injected, the case was sealed. Thus, the non-aqueous electrolyte secondary batteries (test batteries) of Nos. 1 to 5 were manufactured.

### Evaluation

At an environmental temperature of 25°C, the SOC was set to 50%, and the resistance value calculated by the voltage drop from 0 to 1 second when discharging at 3C for 20 seconds was evaluated as R1, and the resistance value calculated by the voltage drop from 1 to 20 seconds was evaluated as R2. The results are shown in Table 1 of FIG. 5. In this example, R1 is a reaction resistance, and R2 is a diffusion resistance. The capacity of each test battery was 6000 mAh.

### Results

As shown in Table 1 of FIG. 5, R1 of No. 4 was lower than those of No. 1 and No. 3, and was equivalent to that of No. 2. Further, R2 of No. 4 was equivalent to those of No. 1 and No. 3, and was lower than that of No. 2. On the other hand, both R1 and R2 of No. 5 showed high values.

### Test Example 2

### Negative Electrode

### No. 6

A second negative electrode slurry and a third negative electrode slurry in which the mixing ratio (mass ratio) of the negative electrode active material, the conductive material, and the binder in the second negative electrode slurry was changed to 98:1:1 were prepared. A negative electrode of No. 6 was produced in the same manner as in No. 3, except that the third negative electrode slurry was applied onto the second negative electrode slurry.

### No. 7

A negative electrode of No. 7 was produced in the same manner as in No. 4, except that the second negative electrode slurry and the third negative electrode slurry were applied in this order. The width of the discharge portion of the die coater at the time of coating with the third negative electrode slurry was set to be longer than the width of the discharge portion of the die coater at the time of coating with the second negative electrode slurry.

### Evaluation

Test batteries No. 6 and No. 7 were manufactured in the same manner as in Test Example 1. The resistance of each test battery was measured in the same manner as in Test Example 1. The results are shown in Table 2 of FIG. 5. Table 2 also shows the evaluation results of No. 2 in which only the second negative electrode slurry was used.

As shown in Table 2 of FIG. 5, R1 of No. 7 was lower than those of Nos. 2 and 6, and R2 of No. 7 was equivalent to those of Nos. 2 and 6.

### Test Example 3

### Negative Electrode

### Nos. 8 to 11

Negative electrodes of Nos. 8 to 11 were manufactured in the same manner as in No. 4, except that the first coating weight and the second coating weight were changed so as to be the values shown in Table 3 of FIG. 5.

### Evaluation

Test batteries Nos. 8 to 11 were manufactured in the same manner as in Test Example 1. The resistance of each test battery was measured in the same manner as in Test Example 1. The results are shown in Table 3 of FIG. 5. Table 3 also shows the evaluation results of No. 4 having the same composition.

As shown in Table 3 of FIG. 5, R1 of each of Nos. 8 to 11 was equivalent to that of No. 4. In addition, R2 of each of Nos. 9 to 11 was equivalent to that of No. 4.

### Test Example 4

### Negative Electrode

### Nos. 12 and 13

Negative electrodes of Nos. 12 and 13 were produced in the same manner as in No. 4, except that the negative electrode active material layer was divided into two parts and three parts.

### Evaluation

Test batteries Nos. 12 and 13 were manufactured in the same manner as in Test Example 1. The resistance of each test battery was measured in the same manner as in Test Example 1. The results are shown in Table 4 of FIG. 5. Table 4 also shows the evaluation results of No. 4 having the same composition, which was not divided.

### Results

As shown in Table 4 of FIG. 5, R1 and R2 of No. 12 were lower than those of No. 4. R1 and R2 of No. 13 showed values lower than those of Nos. 4 and 12.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. An electrode comprising a current collector and an active material layer, wherein
the active material layer includes a first active material layer formed on the current collector, and a second active material layer formed on the first active material layer and the current collector located around the first active material layer, so as to cover the first active material layer,
a reaction resistance of the second active material layer is lower than a reaction resistance of the first active material layer, and
a diffusion resistance of the first active material layer is lower than a diffusion resistance of the second active material layer.

2. The electrode according to claim 1, wherein
the first active material layer includes a first active material,
the second active material layer includes a second active material, and
an average particle size of the second active material is smaller than an average particle size of the first active material.

3. The electrode according to claim 1, wherein
the first active material layer includes a first binder,
the second active material layer includes a second binder, and
a content of the second binder in the second active material layer is lower than a content of the first binder in the first active material layer.

4. The electrode according to claim 1, wherein a coating weight per unit area of the second active material layer is smaller than a coating weight per unit area of the first active material layer.

5. The electrode according to claim 1, wherein the active material layers are formed at intervals.

6. A non-aqueous electrolyte secondary battery comprising an electrode according to claim 1.
